(19) United States
(12) Patent Application Publication
(10) Pub. No.: US 2021/0358322 A1
(43) Pub. Date: Nov. 18, 2021

(54) INSTRUCTIONAL METHOD AND SYSTEM OF ELECTRONIC KEYBOARD, INSTRUCTIONAL ELECTRONIC KEYBOARD AND STORAGE MEDIUM

(71) Applicant: Jia-Yu TSAI, Taipei (TW)

(72) Inventor: Jia-Yu TSAI, Taipei (TW)

(21) Appl. No.: 17/321,510

(22) Filed: May 17, 2021

(30) Foreign Application Priority Data
May 15, 2020 (CN) 202010415299.2

(51) Int. Cl. G09B 15/00; G09B 15/08; G10H 1/00; G10H 1/34

(52) U.S. Cl. CPC G09B 15/003; G10H 1/34; G10H 1/0016; G09B 15/08

(57) ABSTRACT

An instructional method of an electronic keyboard includes: obtaining a playing script, wherein the playing script is generated by a first terminal or a cloud server according to a first signal generated by a recording electronic keyboard and a time point of receiving the first signal, and the playing script is configured to indicate a corresponding relationship between to-be-pressed first keys and time points of pressing the to-be-pressed first keys; and controlling indicator lights on the first keys of the instructional electronic keyboard to be turned on or off according to the playing script. In this way, a user can be prompted to press the keys through the indicator lights on the electronic keyboard, which aids the user in learning how to play the electronic keyboard.

### CROSS REFERENCE TO THE RELATED APPLICATIONS

This application is based upon and claims priority to Chinese Patent Application No. 202010415299.2, filed on May 15, 2020, the entire contents of which are incorporated herein by reference.

### TECHNICAL FIELD

The present invention relates to the technical field of musical instruments, and more particularly, to an instructional method and system of an electronic keyboard, an instructional electronic keyboard, and a storage medium.

### BACKGROUND

As an instrument, an electronic keyboard provides an adjustable volume for sound and, using the various keys and chords, may provide a wide range of sounds and chords resembling an instrumental performance that mimics the sound of an orchestra. The fact that a keyboard with these capabilities can perform this type of music is enormously expressive. Furthermore, the electronic keyboard can also imitate a variety of timbres and even produce sounds (such as chorus, wind and rain sounds, and synthetic sound) that conventional musical instruments cannot produce. When playing a solo, the electronic keyboard can optionally cooperate with rhythmic accompaniments such as the sounds of percussion instruments and is thus suitable for playing modern music with strong rhythms. Moreover, the electronic keyboard is provided with an effects unit (such as reverberation, echo and tenuto), a vibrato unit, a modulation unit, and other multifunctional devices, and thus can easily play various emotive expressions.

Keyboards in the prior art, however, have at least one or more of the following problems. Ordinary people need to spend a great deal of money and time on learning an electronic keyboard. For example, it takes a lot of time and effort to go to music lessons, which directly contributes to lack of learning efficiency.

### SUMMARY

An objective of the present invention is to provide an instructional method and system of an electronic keyboard, an instructional electronic keyboard, and a storage medium, so that a user can be prompted to press the keys by indicator lights on the electronic keyboard, which aids the user in learning the electronic keyboard.

In order to solve the above-mentioned technical problems, an embodiment of the present invention provides an instructional method of an electronic keyboard, including the following steps: obtaining a playing script, wherein the playing script is generated by a first terminal or a cloud server according to a first signal generated by a recording electronic keyboard and a time point of receiving the first signal, and the playing script is configured to indicate a corresponding relationship between to-be-pressed first keys of the instructional electronic keyboard and time points of pressing the first keys; and controlling indicator lights on first keys of the instructional electronic keyboard to be turned on or off according to the playing script.

The embodiment of the present invention further provides an instructional system of an electronic keyboard, including: an instructional electronic keyboard, a recording electronic keyboard, and a first terminal or a cloud server. The recording electronic keyboard generates a first signal to the first terminal or the cloud server according to its own pressed second key. The first terminal or the cloud server generates a playing script according to the first signal generated by the recording electronic keyboard and a time point of receiving the first signal. The playing script is configured to indicate a corresponding relationship between to-be-pressed first keys of the instructional electronic keyboard and time points of pressing the first keys. The instructional electronic keyboard obtains the playing script, and controls indicator lights on the first keys of the instructional electronic keyboard to be turned on or off according to the playing script.

An embodiment of the present invention further provides an instructional electronic keyboard, including: an acquisition module, a control module, and first keys. Indicator lights are provided on the first keys. The acquisition module is configured to obtain a playing script. The playing script is generated by a first terminal or a cloud server according to a first signal generated by a recording electronic keyboard and a time point of receiving the first signal. The playing script is configured to indicate a corresponding relationship between to-be-pressed first keys of the instructional electronic keyboard and time points of pressing the first keys. The control module is configured to control the indicator lights on the first keys of the instructional electronic keyboard to be turned on or off according to the playing script.

The embodiment of the present invention further provides an instructional electronic keyboard, including: at least one processor, a memory communicatively connected to the at least one processor, and a communication component. The communication component is controlled by the at least one processor to receive and transmit data. The memory stores instructions configured to be executed by the at least one processor. When the instructions are executed by the at least one processor, the at least one processor executes the instructional method of the electronic keyboard mentioned in the above embodiment.

The embodiment of the present invention further provides a computer-readable storage medium, wherein a computer program is stored in the computer-readable storage medium, and when the computer program is executed by a processor, the instructional method of the electronic keyboard mentioned in the above embodiment is implemented.

Compared with the prior art, the first terminal or the cloud server, according to the embodiment of the present invention, can generate the playing script, so that the instructional electronic keyboard can obtain and execute the playing script, and control the indicator lights on the first keys of the instructional electronic keyboard to be illuminated. In this way, the user can play musical compositions by observing changes of the indicator lights on the instructional electronic keyboard, which enables the user to learn how to play the keyboard. The instructional electronic keyboard can prompt the user to press the to-be-pressed keys, thereby alleviating the burden of the user of the need to recite musical notations.

In addition, the step of controlling the indicator lights on the first keys of the instructional electronic keyboard to be turned on or off according to the playing script specifically includes: determining a currently to-be-pressed first key according to the playing script and a time point at which the playing starts; and controlling an indicator light corresponding to the currently to-be-pressed first key to be illuminated.

In addition, a virtual canvas is stored in and matched with the instructional electronic keyboard, and the virtual canvas includes N elements that are in a one-to-one correspondence with the indicator lights on the instructional electronic keyboard, wherein N is a positive integer. The playing script includes M key events, each of the M key events records a time point of pressing a key and the to-be-pressed first key at the time point. The step of controlling the indicator lights on the first keys of the instructional electronic keyboard to be turned on or off according to the playing script specifically includes: executing each of the key events in the playing script in sequence according to a sequence of time points recorded by the key events when the keys are pressed. In the process of executing each of the key events, successively performing the following operations: adjusting the elements in the virtual canvas according to a preset prompt rule and the key event, wherein the adjusted virtual canvas instructs the indicator lights on the first keys of the instructional electronic keyboard to be illuminated according to the preset prompt rule to prompt a user to press the to-be-pressed first key at the time point of pressing the key; and driving the indicator lights on the first keys of the instructional electronic keyboard to be illuminated according to the elements in the virtual canvas. In this implementation, the indicator lights are controlled by the virtual canvas, which reduces the influence of key events on each other in complex situations, thereby reducing the burden on the system

In addition, the preset prompt rule includes: according to a preset lighting sequence, controlling the indicator lights on the to-be-pressed first keys to be illuminated in sequence; or, according to the preset lighting sequence, controlling the indicator lights of the to-be-pressed first keys, the indicator lights of the first C keys of the to-be-pressed first keys, and the indicator lights of the last C keys of the to-be-pressed first keys to be illuminated, wherein C is a positive integer and is less than half of the number of the first keys.

In addition, each element in the virtual canvas is a number, and each of the first keys is provided with T indicator lights, wherein T is a positive integer greater than 1. The prompt rule includes: according to the preset lighting sequence, controlling the T indicator lights on the to-be-pressed first key to be illuminated in sequence. The step of adjusting the elements in the virtual canvas according to the key event specifically includes: determining the to-be-pressed first key according to the key event; determining elements in the virtual canvas corresponding to the T indicator lights of the to-be-pressed first key; according to the preset prompt rule, dynamically adjusting values of the elements in the virtual canvas corresponding to the T indicator lights of the to-be-pressed first key. The step of driving the indicator lights on the first keys of the instructional electronic keyboard to be illuminated according to the elements in the virtual canvas specifically includes: according to the values of the elements in the virtual canvas, turning on an indicator light corresponding to an element whose value is not 0; and turning off an indicator light corresponding to an element whose value is 0. In this implementation, the user can determine the time of pressing the first key according to the prompt rule of the T indicator lights on the first key.

In addition, if the playing script is generated by the first terminal, then the playing script is transmitted to the cloud server. The step of obtaining the playing script specifically includes: obtaining a playing script sent by a second terminal, wherein the second terminal determines a playing script selected by a user, obtains the playing script from the cloud server, and transmits the playing script to the instructional electronic keyboard; or receiving the playing script sent by the cloud server. In this implementation, the manufacturing cost of the instructional electronic keyboard is reduced.

In addition, in the process of controlling the indicator lights on the first keys of the instructional electronic keyboard to be turned on or off according to the playing script, the instructional method of the electronic keyboard further includes: recording a pressed first key and a time point of pressing the pressed first key in real time. After the step of controlling the indicator lights on the first keys of the instructional electronic keyboard to be turned on or off according to the playing script, the instructional method of the electronic keyboard further includes: after it is determined that the playing is completed, generating a practice script according to the pressed first key and the time point of pressing the pressed first key that are recorded; transmitting the practice script to the second terminal, so that the second terminal compares the practice script with the playing script, and determines and displays a playing score according to a comparison result. Alternatively, in the process of controlling the indicator lights on the first keys of the instructional electronic keyboard to be turned on or off according to the playing script, the instructional method of the electronic keyboard further includes: sending a second signal to the second terminal according to the pressed first key, so that after determining that the playing is completed, the second terminal generates a practice script according to the second signal and a time point of receiving the second signal; and comparing the practice script with the playing script, and determining and displaying a playing score according to a comparison result. Alternatively, the instructional method of the electronic keyboard further includes: determining a playing score according to the pressed first key and the playing script, and sending the playing score to the second terminal.

In this implementation, the user can objectively know his or her ability to play the electronic keyboard.

In addition, the instructional system of the electronic keyboard further includes: a second terminal. The second terminal is configured to obtain the playing script from the cloud server, and transmit the playing script to the instructional electronic keyboard.

### BRIEF DESCRIPTION OF THE DRAWINGS

One or more embodiments are illustratively described by the corresponding figures in the drawings, and these exemplary descriptions are not intended to constitute a limitation on the embodiments. Components with the same reference numerals in the drawings are denoted as similar components, and the drawings do not constitute a limitation on the scale unless specifically stated.

FIG. 1 is a flow chart schematically showing an instructional method of an electronic keyboard according to a first embodiment of the present invention;

FIG. 2 is a flow chart schematically showing an instructional method of an electronic keyboard according to a second embodiment of the present invention;

FIGS. 3-8 are block diagrams each schematically showing an instructional system of an electronic keyboard according to a third embodiment of the present invention;

FIG. 9 is a block diagram schematically showing an instructional electronic keyboard according to a fourth embodiment of the present invention; and

FIG. 10 is a block diagram schematically showing an instructional electronic keyboard according to a fifth embodiment of the present invention.

### DETAILED DESCRIPTION OF THE EMBODIMENTS

In order to accomplish the objectives, technical solutions and advantages of the embodiments of the present invention, the various embodiments of the present invention will be described in detail below with reference to the drawings. However, it can be understood by those of ordinary skill in the art that many technical details are proposed in various embodiments of the present invention for a better understanding of the present application. Nevertheless, the technical solutions claimed in the present invention can be implemented even without these technical details and various changes and modifications based on the following embodiments.

It should be noted that as can be understood by those skilled in the art, the instructional method of the electronic keyboard provided in the embodiments of the present invention can be applied to various scenarios using the electronic keyboard, e.g. teaching scenarios of the electronic keyboard and entertainment scenarios of the electronic keyboard (e.g. playing competitions or games based on the electronic keyboard).

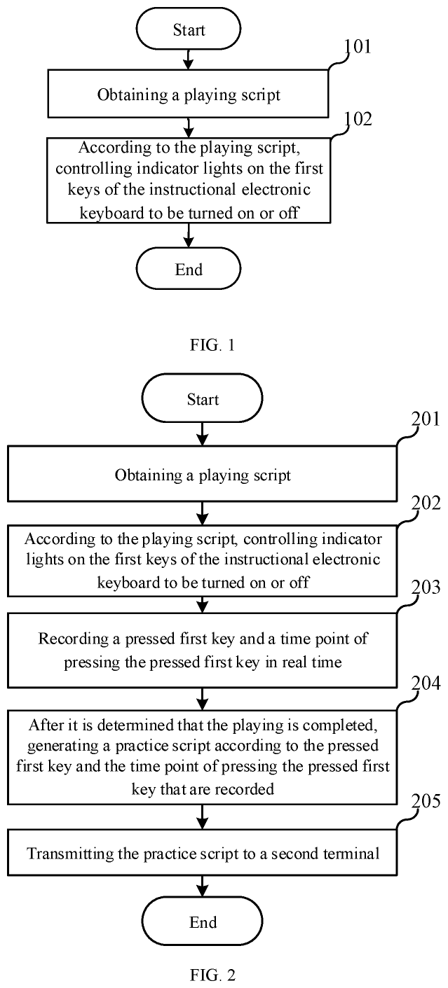

The first embodiment of the present invention provides an instructional method of an electronic keyboard for an instructional electronic keyboard. As shown in FIG. 1, the instructional method of the electronic keyboard includes the following steps.

Step 101: a playing script is obtained.

Specifically, the playing script is generated by a first terminal or a cloud server according to a first signal generated by a recording electronic keyboard and a time point of receiving the first signal. The playing script is configured to indicate a corresponding relationship between to-be-pressed first keys of the instructional electronic keyboard and time points of pressing the first keys. The first signal may be an audio signal.

The process of generating the playing script is illustrated below.

In a playing process, the recording electronic keyboard generates the first signal by reading a pressed second key in real time according to an inductive signal generated by its own press sensing circuit board. The recording electronic keyboard sends the first signal to the first terminal, and the first terminal records the first signal sent by the recording electronic keyboard and a time point of receiving the first signal in a script file. Alternatively, the recording electronic keyboard sends the first signal to the first terminal, the first terminal forwards the received first signal to the cloud server, and the cloud server records the first signal and the time point of receiving the first signal in the script file. Alternatively, the recording electronic keyboard sends the first signal to the cloud server, and the cloud server records the first signal and the time point of receiving the first signal in the script file. After it is determined that the recording ends, the first terminal or the cloud server generates the playing script according to the script file.

In the first example, the first terminal is communicatively connected to the recording electronic keyboard, and the playing script is generated by the first terminal. Specifically, the recording electronic keyboard generates a first signal according to the pressed second key, and sends the first signal to the first terminal. The first terminal generates a playing script according to the first signal sent by the recording electronic keyboard and the time point of receiving the first signal.

Optionally, after generating the playing script, the first terminal transmits the playing script to the cloud server. The instructional electronic keyboard receives the playing script sent by the cloud server. Alternatively, the second terminal determines a playing script selected by a user, obtains the playing script selected by the user from the cloud server, and transmits the playing script selected by the user to the instructional electronic keyboard.

In the second example, the cloud server is communicatively connected to the recording electronic keyboard through the first terminal, and the playing script is generated by the cloud server. Specifically, the recording electronic keyboard generates a first signal according to the pressed second key, and sends the first signal to the first terminal. The first terminal forwards the first signal to the cloud server. The cloud server generates the playing script according to the first signal sent by the recording electronic keyboard and the time point of receiving the first signal.

In the third example, the cloud server is communicatively connected to the recording electronic keyboard, and the playing script is generated by the cloud server. Specifically, the recording electronic keyboard generates a first signal according to the pressed second key, and sends the first signal to the cloud server. The cloud server generates the playing script according to the first signal sent by the recording electronic keyboard and the time point of receiving the first signal.

It should be noted that as can be understood by those skilled in the art, in practical applications, the playing script may also be generated by the recording electronic keyboard according to its own pressed second key and a time point of pressing the second key. The present embodiment does not limit the device that generates the playing script.

For example, the recording electronic keyboard is provided with a reading module, a recording button, a stop button, and a press sensing circuit board. When recording a musical composition, the user A presses the recording button of the recording electronic keyboard before playing the musical composition, and plays the musical composition by the recording electronic keyboard. The reading module reads an inductive signal generated by the press sensing circuit board after determining that the recording button is pressed. At the first moment, the reading module receives a first inductive signal, the first inductive signal indicates that a second key corresponding to note Do is pressed, and the current time is the 1^{st} second after the recording button is pressed. Meanwhile, “the 1^{st} second Do” is recorded in the script file. At the second moment, the reading module receives a second inductive signal, the second inductive signal indicates that a second key corresponding to note Re is pressed, and the current time is the 2^{nd} second after the recording button is pressed. Meanwhile, “the 2^{nd} second Re” is recorded in the script file. At the third moment, the reading module receives a third inductive signal, the third inductive signal indicates that a second key corresponding to note Fa is pressed, and the current time is the 3^{rd} second after the recording button is pressed. Meanwhile, “the 3^{rd} second Fa” is recorded in the script file. The user A presses the stop button after finishing the playing. After detecting that the stop button is pressed, the recording electronic keyboard generates a playing script according to the script file, and information recorded in the playing script is “the 1^{st} second Do, the 2^{nd} second Re, and the 3^{rd} second Fa . . . ”.

It should be noted that as can be understood by those skilled in the art, other methods may also be used to determine to start and stop recording. For example, a method for determining to stop recording includes: when determining that no second key is detected to be pressed within a first preset time, the recording electronic keyboard determines that the playing of the musical composition is completed and stops recording. The first preset time is set as needed, for example, 1 minute. The present embodiment does not limit how the recording electronic keyboard determines the time of starting the recording and the time of stopping the recording.

The process of obtaining the playing script by the instructional electronic keyboard is illustrated below.

Case 1: the instructional electronic keyboard is communicatively connected to the cloud server through the second terminal. The second terminal determines a playing script selected by a user, obtains the playing script selected by the user from the cloud server, and transmits the playing script to the instructional electronic keyboard. The instructional electronic keyboard obtains the playing script sent by the second terminal. The playing script is generated by the cloud server. Alternatively, the playing script is generated by the first terminal, and after the first terminal generates the playing script, the playing script is transmitted to the cloud server.

Case 2: the instructional electronic keyboard is directly communicatively connected to the cloud server. The instructional electronic keyboard determines the playing script selected by the user, and obtains the playing script selected by the user from the cloud server. The playing script is generated by the cloud server. Alternatively, the playing script is generated by the first terminal, and after the first terminal generates the playing script, the playing script is transmitted to the cloud server.

In an example, the recording electronic keyboard and G instructional electronic keyboards are separately connected to the cloud server, wherein G is a positive integer. The recording electronic keyboard sends the first signal to the cloud server in real time according to its own pressed second key. The cloud server generates a playing script according to the received first signal and the time point of receiving the first signal, and broadcasts the playing script. The G instructional electronic keyboards connected to the cloud server receive the broadcast of the cloud server to obtain the playing script, and control the indicator lights to be turned on or off according to the playing script.

Case 3: the instructional electronic keyboard is connected to the first terminal. The instructional electronic keyboard determines the playing script selected by the user, and obtains the playing script selected by the user from the first terminal. The playing script is generated by the first terminal.

Case 4: the instructional electronic keyboard is connected to the first terminal through the second terminal. The second terminal determines a playing script selected by a user, obtains the playing script selected by the user from the first terminal, and transmits the playing script to the instructional electronic keyboard. The instructional electronic keyboard obtains the playing script sent by the second terminal. The playing script is generated by the first terminal.

In an example, the playing script is a playing script of a musical composition. The recording electronic keyboard is connected to the first terminal via Bluetooth, and the instructional electronic keyboard is connected to the second terminal via Bluetooth. After the first terminal generates a playing script of the musical composition and transmits the playing script to the cloud server, or after the cloud server generates the playing script of the musical composition, the playing script of the musical composition and information of the musical composition are stored in the cloud server. The information of the musical composition includes, but is not limited to, the name of the musical composition. The cloud server publishes the information of the recorded musical composition. The second terminal obtains a user's login information, generates a first request based on the user's login information, and sends the first request to the cloud server. The first request instructs the cloud server to return the information of the recorded musical composition. The cloud server receives the first request, and verifies the user's login information in the first request. If it is determined that the user's login information has passed the verification, then first response information is sent to the second terminal. The first response information includes the information of the recorded musical composition. If it is determined that the user's login information has not passed the verification, then second response information is sent to the second terminal. The second response information indicates that the user's login information is incorrect. If the second terminal receives the first response information, then the second terminal displays the information of the recorded musical composition in the first response information. If the second terminal receives the second response information, then the second terminal prompts the user that the login information is incorrect. If the second terminal receives first display information, then after displaying the information of the recorded musical composition in the first response information, the second terminal determines the information of the musical composition selected by the user, and determines a second request according to the information of the musical composition selected by the user. The second request instructs the cloud server to return a playing script corresponding to the information of the musical composition selected by the user. The second terminal sends the second request to the cloud server. The cloud server receives the second request and sends third response information to the second terminal. The third response information includes the playing script corresponding to the information of the musical composition selected by the user. The second terminal receives the third response information, and sends the playing script corresponding to the information of the musical composition selected by the user to the instructional electronic keyboard.

In an example, the information of the musical composition further includes price information of the musical composition, and the second request further includes the user's payment information. The cloud server sends the playing script corresponding to the information of the musical composition selected by the user to the second terminal, provided that the cloud server determines the user's payment information and indicates that the user has paid.

In addition, after the playing script of the musical composition is obtained by the second terminal, the playing script of the musical composition is transmitted to the instructional electronic keyboard via Bluetooth, which reduces the need for the functionality of the instructional electronic keyboard, thereby reducing the cost of the instructional electronic keyboard.

Case 5: the instructional electronic keyboard establishes a communication with the recording electronic keyboard, and the playing script is sent by the recording electronic keyboard to the instructional electronic keyboard.

In an example, a user who uses the recording electronic keyboard to play is an instructor, and a user who uses the instructional electronic keyboard to play is a student who is learning the electronic keyboard. One recording electronic keyboard establishes a communication with multiple instructional electronic keyboards. After generating a playing script, the recording electronic keyboard sends the playing script to all instructional electronic keyboards connected to the recording electronic keyboard, so that each student can follow the instructor to learn the electronic keyboard by observing the on-off state of the indicator lights of the instructional electronic keyboard.

In addition, the recording electronic keyboard is connected to multiple instructional electronic keyboards, so that the multiple instructional electronic keyboards each can prompt the first keys that need to be pressed to facilitate one-to-many instruction.

Step 102: the indicator lights on the first keys of the instructional electronic keyboard are controlled to be turned on or off according to the playing script.

Methods for controlling the indicator lights on the first keys of the instructional electronic keyboard to be illuminated by the instructional electronic keyboard according to the playing script are illustrated below.

Method A: the instructional electronic keyboard determines a currently to-be-pressed first key according to the playing script and a time point at which the playing starts, and controls indicator lights corresponding to the currently to-be-pressed first key to be illuminated. For example, the playing script instructs that a key corresponding to note Fa is pressed at the third second, and a key corresponding to note So is pressed at the fifth second. According to the time point at which the playing starts, when the playing has currently continued for 5 seconds, then the indicator lights of a first key corresponding to note So are illuminated, and the indicator lights of other first keys are turned off.

Method B: a virtual canvas is stored in and matched with the instructional electronic keyboard, and the virtual canvas includes N elements that are in a one-to-one correspondence with the indicator lights on the instructional electronic keyboard, wherein N is a positive integer. The playing script includes M key events, and each of the M key events records a time point of pressing a key and the to-be-pressed first key at the time point. The M key events are arranged in the sequence of the time points of pressing the keys. The step of controlling the indicator lights on the first keys of the instructional electronic keyboard to be turned on or off according to the playing script specifically includes: executing each of the key events in the playing script in sequence according to the sequence of the time points recorded by the key events when the keys are pressed. In the process of executing each of the key events, successively performing the following operations: adjusting the elements in the virtual canvas according to a preset prompt rule and the key event, wherein the adjusted virtual canvas instructs the indicator lights on the first keys of the instructional electronic keyboard to be illuminated according to the preset prompt rule to prompt the user to press a to-be-pressed first key at a time point of pressing the key; and driving the indicator lights on the first keys of the instructional electronic keyboard to be illuminated according to the elements in the virtual canvas.

It should be noted that the prompt rule includes: according to a preset lighting sequence, controlling the indicator lights on the to-be-pressed first keys to be illuminated in sequence. Alternatively, the prompt rule includes: according to the preset lighting sequence, controlling the indicator lights of the to-be-pressed first keys, the indicator lights of the first C keys of the to-be-pressed first keys, and the indicator lights of the last C keys of the to-be-pressed first keys to be illuminated, wherein C is a positive integer and is less than half of the number of the first keys. The present embodiment does not limit the implication of the prompt rule.

In an example, each element in the virtual canvas is a number, the value of the number indicates a brightness value of the indicator light corresponding to a number position, and each key event further records the duration of pressing the to-be-pressed key. The process of adjusting the elements in the virtual canvas by the instructional electronic keyboard according to the key event includes: the instructional electronic keyboard determines a to-be-pressed first key according to the key event and the duration of pressing the to-be-pressed first key; a target value of the element corresponding to the indicator light of the to-be-pressed first key is determined according to the duration of pressing the to-be-pressed first key; and the value of the element corresponding to the indicator light of the to-be-pressed first key in the virtual canvas is adjusted as the target value.

For example, assuming that a constraint relationship between the target value of the element and the duration of pressing the key is: the target value of the element=(the duration of pressing the key)*L, wherein the duration of pressing the key is in unit of seconds, and L is set as needed, for example, 20. When the duration of pressing the key is 2 seconds, the target value of the element is 40.

In an example, each element in the virtual canvas is a number, and each of the first keys is provided with T indicator lights, wherein T is a positive integer greater than 1. The preset prompt rule includes: according to the preset lighting sequence, controlling the T indicator lights on the to-be-pressed first key to be illuminated in sequence. The process of adjusting the elements in the virtual canvas by the instructional electronic keyboard according to the key event includes: determining a to-be-pressed first key according to the key event; determining elements in the virtual canvas corresponding to the T indicator lights of the to-be-pressed first key; and according to the prompt rule, dynamically adjusting the values of the elements in the virtual canvas corresponding to the T indicator lights of the to-be-pressed first key. The process of driving the indicator lights on the first keys of the instructional electronic keyboard to be illuminated by the instructional electronic keyboard according to the elements in the virtual canvas includes: according to the values of the elements in the virtual canvas, turning on an indicator light corresponding to an element whose value is not 0; and turning off an indicator light corresponding to an element whose value is 0.

Specifically, since each element of the virtual canvas is a number, the virtual canvas is equivalent to a matrix of numbers, and the relative positional relationship between the elements is the same as the relative positional relationship between the indicator lights. Assuming that each first key of the instructional electronic keyboard is provided with 5 indicator lights. For example, a first key corresponding to note Do, a first key corresponding to note Re, and a first key corresponding to note Mi in the virtual canvas are expressed in the form as:

| | | |
|---|---|---|
| 0 | 0 | 0 |
| 0 | 0 | 0 |
| 0 | 0 | 0. |
| 0 | 0 | 0 |
| 0 | 0 | 0 |

The changes of the virtual canvas are enumerated below according to different prompt rules.

In the first case, according to a preset lighting sequence, the indicator lights on the to-be-pressed first key are controlled to be illuminated in sequence.

In an example, the preset prompt rule includes: in the first P seconds before the time point of pressing the key, the T indicator lights of the key are illuminated in sequence from top to bottom, and the lighting time of each indicator light is P/(T−1) seconds. Thus, the virtual canvas is updated once every P/(T−1) seconds, and the value of the element corresponding to the indicator light to be illuminated in the virtual canvas is set as Q, wherein Q is a positive number.

Assuming that the key event indicates that the first key corresponding to note Do needs to be pressed at the 10^{th} second, when T is equal to 5 and Q=250, at the (10−P)^{th} second, the elements in the virtual canvas are adjusted as:

| | | |
|---|---|---|
| 250 | 0 | 0 |
| 0 | 0 | 0 |
| 0 | 0 | 0. |
| 0 | 0 | 0 |
| 0 | 0 | 0 |

At the (10−P+1 P/4)^{th} second, the elements in the virtual canvas are adjusted as:

| | | |
|---|---|---|
| 0 | 0 | 0 |
| 250 | 0 | 0 |
| 0 | 0 | 0. |
| 0 | 0 | 0 |
| 0 | 0 | 0 |

At the (10−P+2 P/4)^{th} second, the elements in the virtual canvas are adjusted as:

| | | |
|---|---|---|
| 0 | 0 | 0 |
| 0 | 0 | 0 |
| 250 | 0 | 0. |
| 0 | 0 | 0 |
| 0 | 0 | 0 |

At the (10−P+3P/4)^{th} second, the elements in the virtual canvas are adjusted as:

| | | |
|---|---|---|
| 0 | 0 | 0 |
| 0 | 0 | 0 |
| 0 | 0 | 0. |
| 250 | 0 | 0 |
| 0 | 0 | 0 |

At the 10^{th} second, the elements in the virtual canvas are adjusted as:

| | | |
|---|---|---|
| 0 | 0 | 0 |
| 0 | 0 | 0 |
| 0 | 0 | 0. |
| 0 | 0 | 0 |
| 250 | 0 | 0 |

According to the above description, the instructional method of the electronic keyboard provided in the present embodiment can prompt the user to press the key that is about to be pressed and the time point of pressing the key before the time point of pressing the key.

In an example, the LED driving module in the instructional electronic keyboard controls the lighting state of the solid keys according to the values of the elements in the virtual canvas.

It should be noted that as can be understood by those skilled in the art, in practical applications, the preset prompt rule can be adjusted as needed. For example, the preset prompt rule includes: in the first P seconds before the time point of pressing the key, turning on the T indicator lights of the key in sequence from bottom to top, wherein the lighting time of each indicator light is P/(T−1) seconds. Optionally, the preset prompt rule includes: illuminating from both ends to the middle.

In another example, the preset prompt rule includes: in the first P seconds before the time point of pressing the key, illuminating the T indicator lights of the key in sequence from top to bottom, and updating the virtual canvas once every P/(T−1) seconds. The value of the element corresponding to an indicator light that is newly illuminated in the k^{th} updating process of the virtual canvas is set to Q; the value of the element corresponding to an indicator light that is newly illuminated in the (k−1)^{th} updating process of the virtual canvas is set to Q−B; the value of the element corresponding to an indicator light to be illuminated in the (k−2)^{th} updating process of the virtual canvas is set to Q−2B; . . . and so on, wherein k is less than T, Q is a positive number greater than B, and B is a positive number.

Assuming that the key event indicates that the first key corresponding to note Do needs to be pressed at the 10^{th} second, when T is equal to 5, Q=250 and B=50, at the (10−P)^{th} second, the elements in the virtual canvas are adjusted as:

| | | |
|---|---|---|
| 250 | 0 | 0 |
| 0 | 0 | 0 |
| 0 | 0 | 0. |
| 0 | 0 | 0 |
| 0 | 0 | 0 |

At the (10−P+1 P/4)^{th} second, the elements in the virtual canvas are adjusted as:

| | | |
|---|---|---|
| 200 | 0 | 0 |
| 250 | 0 | 0 |
| 0 | 0 | 0. |
| 0 | 0 | 0 |
| 0 | 0 | 0 |

At the (10−P+2 P/4)^{th} second, the elements in the virtual canvas are adjusted as:

| | | |
|---|---|---|
| 150 | 0 | 0 |
| 200 | 0 | 0 |
| 250 | 0 | 0. |
| 0 | 0 | 0 |
| 0 | 0 | 0 |

At the (10−P+3P/4)^{th} second, the elements in the virtual canvas are adjusted as:

| | | |
|---|---|---|
| 100 | 0 | 0 |
| 150 | 0 | 0 |
| 200 | 0 | 0. |
| 250 | 0 | 0 |
| 0 | 0 | 0 |

At the 10^{th} second, the elements in the virtual canvas are adjusted as:

| | | |
|---|---|---|
| 50 | 0 | 0 |
| 100 | 0 | 0 |
| 150 | 0 | 0. |
| 200 | 0 | 0 |
| 250 | 0 | 0 |

In the second case, the prompt rule includes: controlling the indicator lights of the to-be-pressed first key, the indicator lights of the first C keys of the to-be-pressed first key, and the indicator lights of the last C keys of the to-be-pressed first key to be illuminated according to the preset lighting sequence.

Assuming that the key event indicates that the first key corresponding to note Mi needs to be pressed at the 10^{th} second, when C=2 and each first key is provided with 5 indicator lights, the elements in the virtual canvas corresponding to the indicator lights from the first key corresponding to note Do to the first key corresponding to note So are expressed as:

| | | | | |
|---|---|---|---|---|
| 0 | 0 | 0 | 0 | 0 |
| 0 | 0 | 0 | 0 | 0 |
| 0 | 0 | 0 | 0 | 0. |
| 0 | 0 | 0 | 0 | 0 |
| 0 | 0 | 0 | 0 | 0 |

The lighting sequence includes: at the (10−P)^{th} second, updating the virtual canvas to adjust the elements in the virtual canvas as:

| | | | | |
|---|---|---|---|---|
| 250 | 0 | 0 | 0 | 250 |
| 0 | 0 | 0 | 0 | 0 |
| 0 | 0 | 0 | 0 | 0; |
| 0 | 0 | 0 | 0 | 0 |
| 250 | 0 | 0 | 0 | 250 |

at the (10−P+1 P/2)^{th} second, updating the virtual canvas to adjust the elements in the virtual canvas as:

| | | | | |
|---|---|---|---|---|
| 200 | 0 | 0 | 0 | 200 |
| 0 | 250 | 0 | 250 | 0 |
| 0 | 0 | 0 | 0 | 0; |
| 0 | 250 | 0 | 250 | 0 |
| 200 | 0 | 0 | 0 | 200 |

at the 10^{th} second, updating the virtual canvas to adjust the elements in the virtual canvas as:

| | | | | |
|---|---|---|---|---|
| 150 | 0 | 0 | 0 | 150 |
| 0 | 200 | 0 | 200 | 0 |
| 0 | 0 | 250 | 0 | 0. |
| 0 | 200 | 0 | 200 | 0 |
| 150 | 0 | 0 | 0 | 150 |

It should be noted that the lighting sequence of the indicator lights is set as needed, and the present embodiment does not limit the lighting sequence of the indicator lights.

It should be noted that as can be understood by those skilled in the art, in practical applications, the elements in the virtual canvas may also be other identifiers in addition to numbers, and the present embodiment does not limit the form of the elements in the virtual canvas.

In addition, in an example, the advantages of using the virtual canvas to control the indicator lights are as follows.

(1) In the case of multiple key events occurring at the same time, if the indicator lights are respectively controlled by the key events, it may cause interference between the special effects (i.e., the effect of the indicator lights which are illuminated in sequence) generated by the execution of each key event and destroy the special effects. The special effects are unitedly displayed on the virtual canvas for centralized management, and the special effects are less likely to destroy one another when superimposed.

(2) If the indicator lights are directly controlled by the key events, it would be time-consuming. When the indicator lights are controlled by the system, it takes much more time than processing the virtual canvas. The special effects generated by all key events are unitedly displayed on the virtual canvas, and the patterns of the virtual canvas are displayed on the indicator light in sequence, which reduces the burden on the system.

It should be noted that the above is only an illustrative description, which is not intended to limit the technical solution of the present invention.

Compared with the prior art, the first terminal or the cloud server, according to the embodiment of the present invention, can generate the playing script, so that the instructional electronic keyboard can obtain and execute the playing script, and control the indicator lights on the first keys of the instructional electronic keyboard to be illuminated. In this way, the user can play musical compositions by observing changes of the indicator lights on the instructional electronic keyboard, which enables the user to learn how to play the keyboard. The instructional electronic keyboard can prompt the user to press the to-be-pressed keys, thereby alleviating the burden of the user of the need to recite musical notations. In addition, the instructional electronic keyboard can change the indicator light of the to-be-pressed first key according to the preset prompt rule to prompt the user of the time of pressing the first key. The instructional electronic keyboard can prompt the user of the duration of pressing the first key through the brightness of the indicator light.

The second embodiment of the present invention provides an instructional method of an electronic keyboard. The present embodiment is further improved on the basis of the first embodiment. The specific improvements thereof are as follows: during the playing process, the pressed first key and the time point of pressing the first key are recorded in real time to determine the user's playing score.

Specifically, as shown in FIG. 2, the instructional method of the present embodiment includes steps 201 to 205. Steps 201 and 202 are similar to steps 101 and 102 in the first embodiment, and thus will not be repeated herein. The following is mainly the differences thereof.

Step 201: a playing script is obtained.

Step 202: the indicator lights on the first keys of the instructional electronic keyboard are controlled to be turned on or off according to the playing script.

Step 203: a pressed first key and a time point of pressing the first key are recorded in real time.

Specifically, after determining that a user starts playing, the instructional electronic keyboard starts to record the first key pressed by the user and the time point of pressing the first key.

It should be noted that, for the clarity of illustration, in the present embodiment, step 203 is taken as a follow-up step of step 202. In practical applications, it can be understood by those skilled in the art that steps 202 and 203 can be performed at the same time, and the present embodiment does not limit the sequence of step 202 and step 203.

Step 204: after it is determined that the playing is completed, a practice script is generated according to the pressed first key and the time point of pressing the first key that are recorded.

Specifically, the method for generating the practice script by the instructional electronic keyboard is similar to the method for generating the playing script by the recording electronic keyboard in the first embodiment, and thus will not be repeated herein. Those skilled in the art can execute this step with reference to the relevant contents in the first embodiment.

Step 205: the practice script is transmitted to the second terminal.

Specifically, after receiving the practice script, the second terminal compares the practice script with the playing script, and determines and displays a playing score according to a comparison result.

For example, when the playing starts, the instructional electronic keyboard firstly detects that the first key corresponding to the note Do is pressed by the user, determines a first time point at which the first key corresponding to the note Do is pressed by the user, and generates a first practice event. The first time point and the first key corresponding to the note Do are recorded in the first practice event. When detecting that the first key corresponding to the note Do and the first key corresponding to the note Mi are pressed by the user at the same time, the instructional electronic keyboard determines a second time point at which the first key corresponding to the note Do and the first key corresponding to the note Mi are pressed, and generates a second practice event . . . After the user finishes the playing, the instructional electronic keyboard generates a practice script according to each recorded practice event, and each practice event in the practice script is arranged according to the sequence in which the practice events occur. The practice script is sent to the first terminal by the instructional electronic keyboard. The first terminal sets the playing score to be 100 and performs the following operations for each practice event in the practice script: determining whether there is a key event in the playing script that is the same as the information recorded in the practice event, if yes, the playing score is not changed; and if no, 100/M is subtracted from the playing score.

It should be noted that as can be understood by those skilled in the art, in practical applications, the method for determining the playing score includes: in the process of controlling the indicator lights on the first keys of the instructional electronic keyboard to be turned on or off according to the playing script, the instructional electronic keyboard sends a second signal to the second terminal according to the pressed first key, so that the second terminal generates a practice script according to the second signal and the time point of receiving the second signal after determining that the playing is completed, compares the practice script with the playing script, and determines and displays the playing score according to a comparison result. Optionally, a method for determining the playing score includes: the instructional electronic keyboard determines the playing score according to the pressed first key and the playing script, and sends the playing score to the second terminal; and the second terminal displays the playing score. For example, in the playing process, when detecting that a first key is pressed, the instructional electronic keyboard compares with the playing script based on the pressed first key and the time point of pressing the first key to determine the playing score. Alternatively, when detecting that the first key is pressed, the instructional electronic keyboard records the pressed first key and the time point of pressing the first key, generates a practice script according to the pressed first key and the time point of pressing the first key that are recorded, and determines the playing score by comparing the practice script with the playing script. The present embodiment does not limit the method for determining the playing score.

In addition, the user's practice script is compared with the playing script, so that the user can know his or her playing ability.

It should be noted that the above is only an illustrative description, which is not intended to limit the technical solution of the present invention.

Compared with the prior art, the first terminal or the cloud server, according to the embodiment of the present invention, can generate the playing script, so that the instructional electronic keyboard can obtain and execute the playing script, and control the indicator lights on the first keys of the instructional electronic keyboard to be illuminated. In this way, the user can play musical compositions by observing changes of the indicator lights on the instructional electronic keyboard, which enables the user to learn how to play the keyboard. The instructional electronic keyboard can prompt the user to press the to-be-pressed keys, thereby alleviating the burden of the user of the need to recite musical notations. In addition, the instructional electronic keyboard records the musical composition played by the user and sends the musical composition to the second terminal for scoring, so that the user can know his or her playing level.

The steps of the above-mentioned methods are divided in order to provide a clear description, and the steps can be combined into one step; or some steps can be separated and divided into multiple steps. The steps would fall within the scope of protection of the present invention if the steps include the same logical relationship. Insignificant modifications added to the algorithm or the process or insignificant designs introduced to the algorithm or the process without changing the core design of the algorithm and the process would fall within the scope of protection of the present invention.

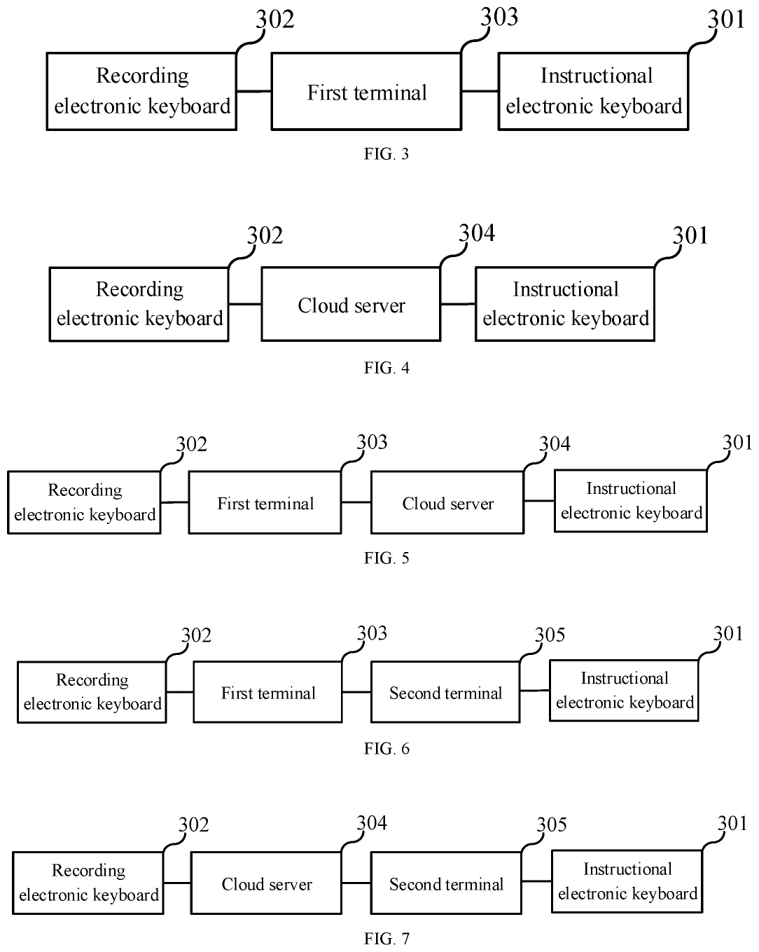

The third embodiment of the present invention provides an instructional system of an electronic keyboard. As shown in FIG. 3, the instructional system includes the instructional electronic keyboard 301, the recording electronic keyboard 302 and the first terminal 303. The recording electronic keyboard 302 generates a first signal to the first terminal 303 according to its own pressed second key. The first terminal 303 generates a playing script according to the first signal generated by the recording electronic keyboard and a time point of receiving the first signal. The playing script is configured to indicate a corresponding relationship between to-be-pressed first keys of the instructional electronic keyboard and time points of pressing the first keys. The instructional electronic keyboard 301 obtains the playing script, and controls the indicator lights on the first keys of the instructional electronic keyboard to be turned on or off according to the playing script.

It should be noted that as can be understood by those skilled in the art, in practical applications, the device that generates the playing script in the instructional system of the electronic keyboard may also be other device such as the cloud server. Other forms of the instructional system of the electronic keyboard are illustrated below.

In an example, as shown in FIG. 4, the instructional system of the electronic keyboard includes the instructional electronic keyboard 301, the recording electronic keyboard 302 and the cloud server 304. The recording electronic keyboard 302 sends a first signal to the cloud server 304 according to its own pressed second key. The cloud server 304 generates a playing script according to the first signal generated by the recording electronic keyboard 302 and a time point of receiving the first signal. The playing script is configured to indicate a corresponding relationship between to-be-pressed first keys of the instructional electronic keyboard and time points of pressing the first keys. The instructional electronic keyboard 301 obtains the playing script from the cloud server 304, and controls the indicator lights on the first keys of the instructional electronic keyboard to be turned on or off according to the playing script.

In an example, as shown in FIG. 5, the instructional system of the electronic keyboard includes the instructional electronic keyboard 301, the recording electronic keyboard 302, the first terminal 303 and the cloud server 304. The recording electronic keyboard 302 sends a first signal to the first terminal 303 according to its own pressed second key. The first terminal 303 generates a playing script according to the first signal sent by the recording electronic keyboard 302 and a time point of receiving the first signal, and transmits the playing script to the cloud server 304. Alternatively, the first terminal 303 transmits the first signal sent by the recording electronic keyboard 302 to the cloud server 304, and the cloud server generates a playing script according to the first signal sent by the recording electronic keyboard 302 and the time point of receiving the first signal. The instructional electronic keyboard 301 obtains the playing script from the cloud server 304, and controls the indicator lights on the first keys of the instructional electronic keyboard 301 to be turned on or off according to the playing script.

In an example, as shown in FIG. 6, the instructional system of the electronic keyboard includes the instructional electronic keyboard 301, the recording electronic keyboard 302, the first terminal 303 and the second terminal 305. The recording electronic keyboard 302 sends a first signal to the first terminal 303 according to its own pressed second key. The first terminal 303 generates a playing script according to the first signal sent by the recording electronic keyboard 302 and the time point of receiving the first signal. The second terminal 305 is communicatively connected to the first terminal 303, obtains the playing script from the first terminal 303, and transmits the playing script to the instructional electronic keyboard 301. The instructional electronic keyboard 301 obtains the playing script from the second terminal 305, and controls the indicator lights on the first keys of the instructional electronic keyboard 301 to be turned on or off according to the playing script.

In an example, as shown in FIG. 7, the instructional system of the electronic keyboard includes the instructional electronic keyboard 301, the recording electronic keyboard 302, the cloud server 304 and the second terminal 305. The recording electronic keyboard 302 sends a first signal to the cloud server 304 according to its own pressed second key. The cloud server 304 generates a playing script according to the first signal sent by the recording electronic keyboard 302 and the time point of receiving the first signal. The second terminal 305 obtains the playing script from the cloud server 304 and transmits the playing script to the instructional electronic keyboard 301. The instructional electronic keyboard 301 obtains the playing script from the second terminal 305, and controls the indicator lights on the first keys of the instructional electronic keyboard 301 to be turned on or off according to the playing script.

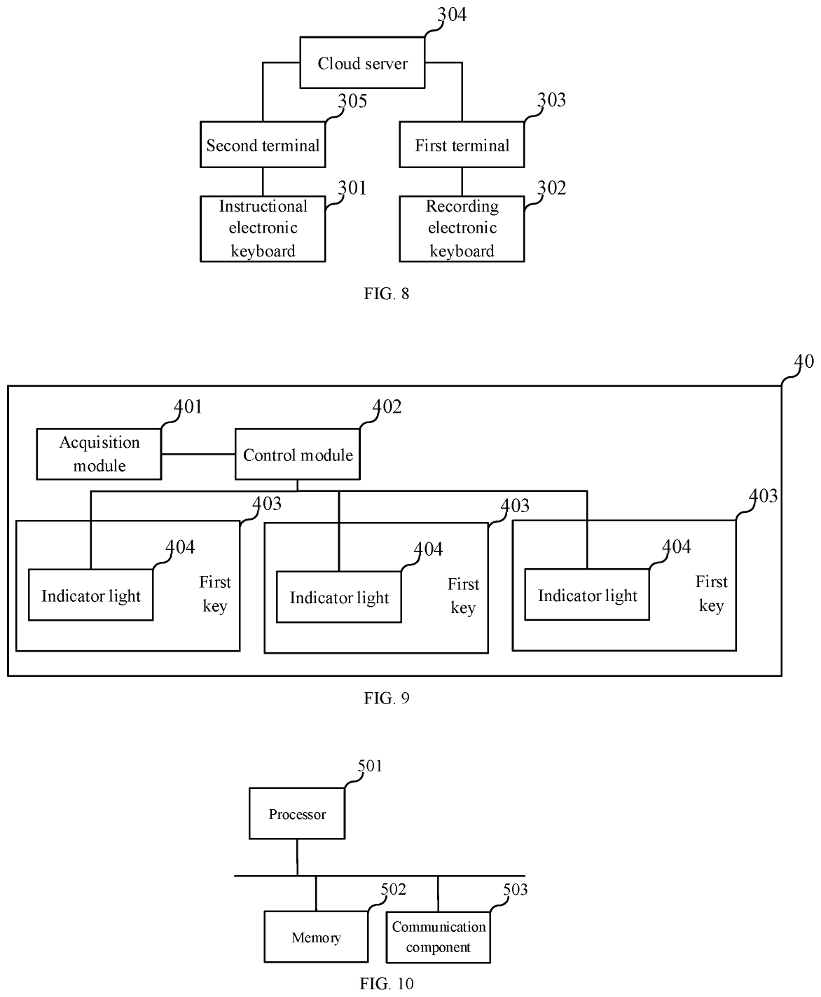

In an example, as shown in FIG. 8, the instructional system of the electronic keyboard includes the instructional electronic keyboard 301, the recording electronic keyboard 302, the first terminal 303, the second terminal 305 and the cloud server 304. After the first terminal 303 or the cloud server 304 generates the playing script, the second terminal 305 obtains the playing script from the cloud server 304 and transmits the playing script to the instructional electronic keyboard 301.

In an example, the instructional system of the electronic keyboard includes: a recording electronic keyboard and G instructional electronic keyboards. The recording electronic keyboard and the G instructional electronic keyboards are separately connected to a cloud server, wherein G is a positive integer. The recording electronic keyboard generates a playing script according to its own pressed second key and the time point of pressing the second key in real time, and sends the playing script to the cloud server. The cloud server broadcasts the playing script. The G instructional electronic keyboards connected to the cloud server receive the broadcast of the cloud server to obtain the playing script, and control the indicator lights to be turned on or off according to the playing script to realize real-time instruction.

Obviously, the present embodiment is a system embodiment corresponding to the first embodiment, and the present embodiment can be implemented in cooperation with the first embodiment. The related technical details mentioned in the first embodiment are still effective in the present embodiment, and will not be repeated herein. Accordingly, the related technical details mentioned in the present embodiment can also be applied in the first embodiment.

In addition, each module referring to in the present embodiment is a logic module. In practical applications, a logical unit may be a physical unit, or a part of the physical unit, or a combination of a plurality of physical units. Besides, in order to focus on the creative part of the present invention, units without a close bond to solving the technical problem proposed by the present invention are not introduced in the present embodiment, but this does not mean that there are no other units in the present embodiment.

The fourth embodiment of the present invention provides the instructional electronic keyboard 40. As shown in FIG. 9, the instructional electronic keyboard 40 includes the acquisition module 401, the control module 402, and the first keys 403. The indicator light 404 is provided on the first key 403. The acquisition module 401 is configured to obtain a playing script. The playing script is generated by a first terminal or a cloud server according to a first signal generated by a recording electronic keyboard and a time point of receiving the first signal. The playing script is configured to indicate a corresponding relationship between the to-be-pressed first keys and the time points of pressing the first keys. The control module 402 is configured to control the indicator lights 404 on the first keys of the instructional electronic keyboard to be turned on and off according to the playing script.

It should be noted that as can be understood by those skilled in the art, the recording electronic keyboard may be other electronic keyboards other than the instructional electronic keyboard, or may be the instructional electronic keyboard itself.

It should be noted that as can be understood by those skilled in the art, FIG. 9 illustrates an example where the instructional electronic keyboard 40 includes three first keys 403 each including one indicator light 404. In practical applications, the number of indicator lights of the instructional electronic keyboard 40 may be other positive integers, and each first key 403 may also be provided with multiple indicator lights. The present embodiment does not limit the number of the first keys 403 and the number of the indicator lights 404 on each first key 403.

Obviously, the present embodiment is a device embodiment corresponding to the first embodiment, and the present embodiment can be implemented in cooperation with the first embodiment. The related technical details mentioned in the first embodiment are still effective in the present embodiment, and will not be repeated herein. Accordingly, the related technical details mentioned in the present embodiment can also be applied in the first embodiment.

In addition, each module referring to in the present embodiment is a logic module. In practical applications, a logical unit may be a physical unit, or a part of the physical unit, or a combination of a plurality of physical units. Besides, in order to focus on the creative part of the present invention, units without a close bond to solving the technical problem proposed by the present invention are not introduced in the present embodiment, but this does not mean that there are no other units in the present embodiment.

The fifth embodiment of the present invention provides an instructional electronic keyboard. As shown in FIG. 10, the instructional electronic keyboard includes at least one processor 501, the memory 502 communicatively connected to the at least one processor 501, and the communication component 503. The communication component 503 receives and sends data under the control of the processor 501. The memory 502 stores instructions configured to be executed by the at least one processor 501. When the instructions are executed by the at least one processor 501, the at least one processor 501 executes the instructional method of the electronic keyboard mentioned in the above embodiments.

The electronic keyboard includes one or more processors 501 and the memory 502. FIG. 10 illustrates an example where the electronic keyboard includes one processor 501. The processor 501 and the memory 502 are connected through a bus or in other ways. FIG. 10 illustrates an example where the processor 501 and the memory 502 are connected through a bus. As a non-volatile computer-readable storage medium, the memory 502 can be configured to store non-volatile software programs, non-volatile computer-executable programs, and modules. The processor 501 runs the non-volatile software programs, instructions, and modules stored in the memory 502 to execute various functional applications and data processing of the device, thereby implementing the instructional method of the electronic keyboard described above.

The memory 502 includes a program storage area and a data storage area. The program storage area can store an operating system and an application program required for at least one function. The data storage area can store a list of options and the like. In addition, the memory 502 includes a high-speed random access memory, or a non-volatile memory, such as at least one magnetic disk storage device, a flash memory device, or other non-volatile solid-state storage devices. In some embodiments, the memory 502 optionally includes memories remotely set relative to the processor 501, and these remote memories may be connected to an external device through a network. Examples of the aforementioned network include, but are not limited to, the Internet, an intranet, a local area network, a mobile communication network, and combinations thereof.

One or more modules are stored in the memory 502, and when the one or more modules are executed by one or more processors 501, the instructional method of the electronic keyboard in any one of the above method embodiments is executed.

The above-mentioned product can execute the method provided by the embodiments of the present invention, and has the corresponding functional modules and advantages of executing the method. The technical details not described in the present embodiment can refer to the method provided in the embodiments of the present invention.

The sixth embodiment of the present invention provides a computer-readable storage medium in which a computer program is stored, and when the computer program is executed by the processor, the above method embodiment is implemented.

It can be understood by those skilled in the art that all or part of the steps in the method of the above embodiments can be implemented by instructing relevant hardware through a program. The program is stored in a storage medium and includes several instructions to enable a device (which may be a single-chip microcomputer, a chip, or the like) or a processor to execute all or part of the steps of the methods described in the embodiments of the present invention. Moreover, the aforementioned storage medium includes a USB flash drive, a mobile hard disk, a read-only memory (ROM), a random access memory (RAM), a magnetic disk, an optical disk, or other mediums that can store program codes.

It can be understood by those of ordinary skill in the art that the above embodiments are specific embodiments for implementing the present invention, but in practical applications, various changes can be made to these embodiments in terms of forms and details without departing from the spirit and scope of the present invention.

What is claimed is:

1. An instructional method of an electronic keyboard for an instructional electronic keyboard, comprising the following steps:
obtaining a playing script, wherein the playing script is generated by a first terminal or a cloud server according to a first signal generated by a recording electronic keyboard and a time point of receiving the first signal, and the playing script is configured to indicate a corresponding relationship between to-be-pressed first keys of the instructional electronic keyboard and time points of pressing the to-be-pressed first keys; and
controlling indicator lights on first keys of the instructional electronic keyboard to be turned on or off according to the playing script.

2. The instructional method according to claim 1, wherein
the step of controlling the indicator lights on the first keys of the instructional electronic keyboard to be turned on or off according to the playing script specifically comprises:
determining a currently to-be-pressed first key according to the playing script and a time point of starting playing; and
controlling an indicator light corresponding to the currently to-be-pressed first key to be illuminated.

3. The instructional method according to claim 1, wherein
a virtual canvas is stored in and matched with the instructional electronic keyboard, and the virtual canvas comprises N elements;
the N elements are in a one-to-one correspondence with the indicator lights on the first keys of the instructional electronic keyboard, wherein N is a positive integer;
the playing script comprises M key events;
the M key events record the time points of pressing the to-be-pressed first keys and the to-be-pressed first keys at the time points;
the step of controlling the indicator lights on the first keys of the instructional electronic keyboard to be turned on or off according to the playing script specifically comprises:
executing the M key events in the playing script in sequence according to a sequence of time points recorded by the M key events when the to-be-pressed first keys are pressed; and
when each of the M key events is executed, the instructional method further comprises:
adjusting the N elements in the virtual canvas according to a preset prompt rule and the M key events to obtain an adjusted virtual canvas, wherein the adjusted virtual canvas instructs the indicator lights on the first keys of the instructional electronic keyboard to be illuminated according to the preset prompt rule to prompt a user to press the to-be-pressed first keys at the time points of pressing the to-be-pressed first keys; and
driving the indicator lights on the first keys of the instructional electronic keyboard to be illuminated according to the N elements in the virtual canvas.

4. The instructional method according to claim 3, wherein
the preset prompt rule comprises:
according to a preset lighting sequence, controlling the indicator lights on the to-be-pressed first keys to be illuminated in sequence; or
according to the preset lighting sequence, controlling the indicator lights of the to-be-pressed first keys, indicator lights of first C keys of the to-be-pressed first keys, and indicator lights of last C keys of the to-be-pressed first keys to be illuminated, wherein C is a positive integer and C is less than half of a number of the first keys.

5. The instructional method according to claim 4, wherein
each element of the N elements in the virtual canvas is a number, and each of the first keys is provided with T indicator lights, wherein T is a positive integer greater than 1;
the preset prompt rule comprises:
according to the preset lighting sequence, controlling the T indicator lights on a to-be-pressed first key of the to-be-pressed first keys to be illuminated in sequence;
the step of adjusting the N elements in the virtual canvas according to the M key events specifically comprises:
determining the to-be-pressed first keys according to the M key events;
determining the N elements in the virtual canvas corresponding to the T indicator lights of the to-be-pressed first key; and
according to the preset prompt rule, dynamically adjusting values of the N elements in the virtual canvas corresponding to the T indicator lights of the to-be-pressed first key;
the step of driving the indicator lights on the first keys of the instructional electronic keyboard to be illuminated according to the N elements in the virtual canvas specifically comprises:
according to the values of the N elements in the virtual canvas, turning on an indicator light corresponding to a first element, wherein a value of the first element is not 0; and turning off an indicator light corresponding to a second element, wherein a value of the second element is 0.

6. The instructional method according to claim 1, wherein
if the playing script is generated by the first terminal, then the playing script is transmitted to the cloud server;
the step of obtaining the playing script specifically comprises:
obtaining the playing script sent by a second terminal, wherein the second terminal determines the playing script selected by a user, the second terminal obtains the playing script from the cloud server, and the second terminal transmits the playing script to the instructional electronic keyboard; or
receiving the playing script sent by the cloud server.

7. The instructional method according to claim 6, wherein
in the process of controlling the indicator lights on the first keys of the instructional electronic keyboard to be turned on or off according to the playing script, the instructional method further comprises:
recording a pressed first key and a time point of pressing the pressed first key in real time;
after the step of controlling the indicator lights on the first keys of the instructional electronic keyboard to be turned on or off according to the playing script, the instructional method further comprises:
after it is determined that playing is completed, generating a practice script according to the pressed first key and the time point of pressing the pressed first key, wherein the pressed first key and the time point of pressing the pressed first key are recorded; transmitting the practice script to the second terminal, wherein the second terminal compares the practice script with the playing script, and the second terminal determines and displays a playing score according to a comparison result; or
in the process of controlling the indicator lights on the first keys of the instructional electronic keyboard to be turned on or off according to the playing script, the instructional method further comprises:
sending a second signal to the second terminal according to the pressed first key, wherein the second terminal generates the practice script according to the second signal and a time point of receiving the second signal after determining that the playing is completed; and comparing the practice script with the playing script, and determining and displaying the playing score according to the comparison result; or
the instructional method further comprises:
determining the playing score according to the pressed first key and the playing script, and sending the playing score to the second terminal.

8. An instructional system of an electronic keyboard, comprising:
an instructional electronic keyboard, a recording electronic keyboard, and a first terminal or a cloud server; wherein
the recording electronic keyboard generates a first signal to the first terminal or the cloud server according to a pressed second key, wherein the pressed second key is owned by the recording electronic keyboard;
the first terminal or the cloud server generates a playing script according to the first signal generated by the recording electronic keyboard and a time point of receiving the first signal, wherein the playing script is configured to indicate a corresponding relationship between to-be-pressed first keys of the instructional electronic keyboard and time points of pressing the to-be-pressed first keys; and
the instructional electronic keyboard obtains the playing script, and the instructional electronic keyboard controls indicator lights on first keys of the instructional electronic keyboard to be turned on or off according to the playing script.

9. The instructional system according to claim 8, wherein
the instructional system further comprises a second terminal; and
the second terminal is configured to obtain the playing script from the cloud server, and transmit the playing script to the instructional electronic keyboard.

10. An instructional electronic keyboard, comprising:
an acquisition module,
a control module, and
first keys;
wherein indicator lights are provided on the first keys;
the acquisition module is configured to obtain a playing script, and the playing script is generated by a first terminal or a cloud server according to a first signal generated by a recording electronic keyboard and a time point of receiving the first signal, and the playing script is configured to indicate a corresponding relationship between to-be-pressed first keys of the instructional electronic keyboard and time points of pressing the to-be-pressed first keys; and
the control module is configured to control the indicator lights on the first keys of the instructional electronic keyboard to be turned on or off according to the playing script.

11. An instructional electronic keyboard, comprising:
at least one processor,
a memory communicatively connected to the at least one processor, and
a communication component;
wherein
the communication component is controlled by the at least one processor to receive and transmit data;
the memory stores instructions configured to be executed by the at least one processor, and when the instructions are executed by the at least one processor, the at least one processor executes the instructional method according to claim 1.

12. A computer-readable storage medium, wherein
a computer program is stored in the computer-readable storage medium, and
when the computer program is executed by a processor, the instructional method according to claim 1 is implemented.

13. The instructional method according to claim 2, wherein
if the playing script is generated by the first terminal, then the playing script is transmitted to the cloud server;
the step of obtaining the playing script specifically comprises:
obtaining the playing script sent by a second terminal, wherein the second terminal determines the playing script selected by a user, the second terminal obtains the playing script from the cloud server, and the second terminal transmits the playing script to the instructional electronic keyboard; or
receiving the playing script sent by the cloud server.

14. The instructional method according to claim 3, wherein
if the playing script is generated by the first terminal, then the playing script is transmitted to the cloud server;
the step of obtaining the playing script specifically comprises:
obtaining the playing script sent by a second terminal, wherein the second terminal determines the playing script selected by a user, the second terminal obtains the playing script from the cloud server, and the second terminal transmits the playing script to the instructional electronic keyboard; or
receiving the playing script sent by the cloud server.

15. The instructional method according to claim 4, wherein
if the playing script is generated by the first terminal, then the playing script is transmitted to the cloud server;
the step of obtaining the playing script specifically comprises:
obtaining the playing script sent by a second terminal, wherein the second terminal determines the playing script selected by a user, the second terminal obtains the playing script from the cloud server, and the second terminal transmits the playing script to the instructional electronic keyboard; or
receiving the playing script sent by the cloud server.

16. The instructional method according to claim 5, wherein
if the playing script is generated by the first terminal, then the playing script is transmitted to the cloud server;
the step of obtaining the playing script specifically comprises:
obtaining the playing script sent by a second terminal, wherein the second terminal determines the playing script selected by a user, the second terminal obtains the playing script from the cloud server, and the second terminal transmits the playing script to the instructional electronic keyboard; or
receiving the playing script sent by the cloud server.

17. The instructional method according to claim 13, wherein
in the process of controlling the indicator lights on the first keys of the instructional electronic keyboard to be turned on or off according to the playing script, the instructional method further comprises:
recording a pressed first key and a time point of pressing the pressed first key in real time;
after the step of controlling the indicator lights on the first keys of the instructional electronic keyboard to be turned on or off according to the playing script, the instructional method further comprises:
after it is determined that the playing is completed, generating a practice script according to the pressed first key and the time point of pressing the pressed first key, wherein the pressed first key and the time point of pressing the pressed first key are recorded; transmitting the practice script to the second terminal, wherein the second terminal compares the practice script with the playing script, and the second terminal determines and displays a playing score according to a comparison result; or
in the process of controlling the indicator lights on the first keys of the instructional electronic keyboard to be turned on or off according to the playing script, the instructional method further comprises:
sending a second signal to the second terminal according to the pressed first key, wherein the second terminal generates the practice script according to the second signal and a time point of receiving the second signal after determining that the playing is completed; and comparing the practice script with the playing script, and determining and displaying the playing score according to the comparison result; or
the instructional method further comprises:
determining the playing score according to the pressed first key and the playing script, and sending the playing score to the second terminal.

18. The instructional method according to claim 14, wherein
in the process of controlling the indicator lights on the first keys of the instructional electronic keyboard to be turned on or off according to the playing script, the instructional method further comprises:
recording a pressed first key and a time point of pressing the pressed first key in real time;
after the step of controlling the indicator lights on the first keys of the instructional electronic keyboard to be turned on or off according to the playing script, the instructional method further comprises:
after it is determined that playing is completed, generating a practice script according to the pressed first key and the time point of pressing the pressed first key, wherein the pressed first key and the time point of pressing the pressed first key are recorded; transmitting the practice script to the second terminal, wherein the second terminal compares the practice script with the playing script, and the second terminal determines and displays a playing score according to a comparison result; or
in the process of controlling the indicator lights on the first keys of the instructional electronic keyboard to be turned on or off according to the playing script, the instructional method further comprises:
sending a second signal to the second terminal according to the pressed first key, wherein the second terminal generates the practice script according to the second signal and a time point of receiving the second signal after determining that the playing is completed; and comparing the practice script with the playing script, and determining and displaying the playing score according to the comparison result; or
the instructional method further comprises:
determining the playing score according to the pressed first key and the playing script, and sending the playing score to the second terminal.

19. The instructional method according to claim 15, wherein
in the process of controlling the indicator lights on the first keys of the instructional electronic keyboard to be turned on or off according to the playing script, the instructional method further comprises:
recording a pressed first key and a time point of pressing the pressed first key in real time;
after the step of controlling the indicator lights on the first keys of the instructional electronic keyboard to be turned on or off according to the playing script, the instructional method further comprises:
after it is determined that playing is completed, generating a practice script according to the pressed first key and the time point of pressing the pressed first key, wherein the pressed first key and the time point of pressing the pressed first key are recorded; transmitting the practice script to the second terminal, wherein the second terminal compares the practice script with the playing script, and the second terminal determines and displays a playing score according to a comparison result; or
in the process of controlling the indicator lights on the first keys of the instructional electronic keyboard to be turned on or off according to the playing script, the instructional method further comprises:
sending a second signal to the second terminal according to the pressed first key, wherein the second terminal generates the practice script according to the second signal and a time point of receiving the second signal after determining that the playing is completed; and comparing the practice script with the playing script, and determining and displaying the playing score according to the comparison result; or
the instructional method further comprises:
determining the playing score according to the pressed first key and the playing script, and sending the playing score to the second terminal.

20. The instructional method according to claim 16, wherein
in the process of controlling the indicator lights on the first keys of the instructional electronic keyboard to be turned on or off according to the playing script, the instructional method further comprises:
recording a pressed first key and a time point of pressing the pressed first key in real time;
after the step of controlling the indicator lights on the first keys of the instructional electronic keyboard to be turned on or off according to the playing script, the instructional method further comprises:
after it is determined that playing is completed, generating a practice script according to the pressed first key and the time point of pressing the pressed first key, wherein the pressed first key and the time point of pressing the pressed first key are recorded; transmitting the practice script to the second terminal, wherein the second terminal compares the practice script with the playing script, and the second terminal determines and displays a playing score according to a comparison result; or
in the process of controlling the indicator lights on the first keys of the instructional electronic keyboard to be turned on or off according to the playing script, the instructional method further comprises:
sending a second signal to the second terminal according to the pressed first key, wherein the second terminal generates the practice script according to the second signal and a time point of receiving the second signal after determining that the playing is completed; and comparing the practice script with the playing script, and determining and displaying the playing score according to the comparison result; or
the instructional method further comprises:
determining the playing score according to the pressed first key and the playing script, and sending the playing score to the second terminal.
